(19) United States
(12) Patent Application Publication
(10) Pub. No.: US 2013/0130078 A1
(43) Pub. Date: May 23, 2013

(54) BATTERY HOUSING FOR HOLDING ELECTROCHEMICAL ENERGY STORAGE DEVICES

(71) Applicants: Tim Schaefer, Harztor (DE); Claus-Rupert Hohenthanner, Hanau (DE)

(72) Inventors: Tim Schaefer, Harztor (DE); Claus-Rupert Hohenthanner, Hanau (DE)

(73) Assignee: Li-Tec Battery GmbH, Kamenz (DE)

(21) Appl. No.: 13/510,291

(22) PCT Filed: Nov. 15, 2010
(86) PCT No.: PCT/EP2010/006936

§ 371 Date: Aug. 6, 2012

(30) Foreign Application Priority Data
Nov. 16, 2009 (DE) 10 2009 053 506.3

(51) Int. Cl. H01M 10/50

(52) U.S. Cl. CPC H01M 10/5042
USPC 429/72; 429/99; 29/428

(57) ABSTRACT

A battery housing surrounds at least one but preferably a multiplicity of electrochemical energy storage devices. The battery housing has at least one but preferably a multiplicity of cell compartments to hold these electrochemical energy storage devices. The surface of the battery housing consists of four side surfaces, a bottom surface and a top surface, with the side surfaces being formed by the cell compartment elements. Two electrochemical energy storage devices are preferably arranged in one cell compartment. In particular, an elastic equalizing element is arranged between two electrochemical energy storage devices. The cell compartments are formed by cell compartment elements. In particular, a cell compartment element forms at least one cell compartment, and two cell compartment elements preferably form one cell compartment. The cell compartments can be closed, in particular, by a cover element.

### CROSS-REFERENCE TO RELATED APPLICATIONS

This application is a national stage application under 35 U.S.C. §371 of International Application No. PCT/EP2010/006936, filed Nov. 15, 2010 and published as WO 2011/057815, which claims priority to German patent application number DE 10 2009 053 506.3, filed on Nov. 16, 2009, the entirety of each of which is hereby incorporated herein by reference.

### SUMMARY

The present invention relates to a battery housing for holding a plurality of electrochemical energy storage devices and a method for producing such a battery housing.

For the purposes of the present invention, a battery housing encloses at least two electrochemical energy storage devices, essentially with rigid walls. Such a battery housing preferably includes a number of cell compartments, but particularly at least one cell compartment, one or more electrochemical energy storage devices being arranged in a cell compartment. The battery housing is intended to prevent the electrochemical energy storage devices from being exposed to external stresses such as the application of a force, and to help maintain an even temperature.

Battery housings used in the past help to maintain an even temperature of the electrochemical energy storage devices by means of a relatively complex spatial arrangement of the devices, as described for example in DE 10 2008 014 155 A1. This type of arrangement can be achieved using housing elements such as those described for example in DE 10 2007 063 269 A1, but some such elements are complicated. Complex housings are mechanical components that are difficult to manufacture. One purpose of the present invention is therefore to provide a battery housing for electrochemical energy storage devices that is easy to manufacture.

The object of the present invention is therefore to provide a battery housing that helps to increase the operational reliability of electrochemical energy storage devices.

This is achieved according to the present invention by the teaching of the independent claims. Preferred refinements of the present invention are the object of the dependent claims.

A battery housing surround at least one but preferably a number of electrochemical energy storage devices. The battery housing comprises at least one but preferably a number of cell compartments for the purpose of holding these electrochemical energy storage devices. The surface of the battery housing consists of four side surfaces, a bottom surface and a top surface, the side surfaces being formed by the cell compartment elements. Preferably, two electrochemical energy storage devices are located in one cell compartment. In particular, an elastic equalizing element is arranged between two electrochemical energy storage devices. The cell compartments are formed by cell compartment elements. In particular, one cell compartment element forms at least one cell compartment, and two cell compartment elements preferably form one cell compartment. In particular, the cell compartments are closable with a cover element.

An electrochemical energy storage device comprises at least an electrode stack, a current collector and an encasement. An electrochemical energy storage device is designed to convert electrical energy into chemical energy and store it. Conversely, the electrochemical energy storage device can convert the chemical energy back into electrical energy and deliver it. Such an electrochemical energy storage device preferably has the form of a lithium ion rechargeable battery.

A cell compartment element is understood to be a thin-walled shaped part that essentially delimits a cell compartment. At least a section of a cell compartment's wall forms at least a section of the outer surface of this battery housing, preferably a section the lateral wall of the battery housing. There is preferably a thermally conductive connection between a cell compartment element and at least one electrochemical energy storage device.

A side wall of the battery housing is understood to mean the lateral delimitation of the battery housing. This side wall isolates a section of the items contained in the battery housing from the atmosphere surrounding the battery housing. This side wall is particularly formed by cell compartment elements.

A cover element according to the present invention is understood to mean a component or device that is designed to close the opening at the edge of a cell compartment. Depending on the design of the cell compartment element, a cell compartment particularly has one or preferably two edge openings. In this way, a cover element preferably isolates at least sections of the items contained in the battery housing from the atmosphere surrounding the battery housing. In particular, a cover element is designed to assure the targeted flow of a temperature regulating medium to and from the cell compartment elements. A cover element is preferably furnished with cavities for directing the temperature regulating medium. These cavities are particularly conformed such that a temperature regulating medium is not only able to flow through the cell compartment elements one after the other, but particularly so that two or more streams of temperature regulating medium are able to flow through the cell compartment elements one after the other. In particular, the medium may flow through the cell compartment elements in any sequence due to a predetermined configuration of these cavities. In particular, these cavities may be configured in such manner that the temperature regulating medium flows through at least two, or preferably all cell compartment elements at the same time. In particular, devices may be embedded in a cover element that are designed to actively direct the flow of the temperature regulating medium.

Active direction of the temperature regulating medium is understood to mean that predetermined cavities in the cover element may be opened or closed particularly in response to external control commands or depending on the temperature of the temperature regulating medium. In particular, thermostats or valves are provided for directing the flow of the temperature regulating medium.

A partition wall is understood to mean a wall extending inside the battery housing that may be furnished with cavities and/or recesses. This wall preferably delimits at least areas of the cell compartments and is a part of the cell compartment element.

For the purposes of the present invention, a connecting element is understood to be a component that is provided to create a positive locking connection between a cover element and at least one cell compartment element.

A snap-on connection in the context of the present invention is a positive locking connection that creates a connection between a cover element and at least one cell compartment element without the use of additional components.

For the purposes of the present invention, a connection area is understood to mean a specific section of a cell compartment element. In this connection area, a first cell compartment element is in contact with a second cell compartment element.

According to the present invention, a temperature regulating medium is understood to be a gas- or liquid-phase fluid. The temperature regulating medium is provided in order to convey an energy stream to and from the battery housing.

For the purposes of the present invention, perfusion channels are understood to be cavities in the battery housing. The temperature regulating medium flows through these cavities in controlled manner and they may be located in one or more cover elements and in one or more cell compartment elements.

The cell compartment elements are particularly made from a metal material, or preferably from a fibre reinforced composite. This is particularly a material having high thermal conductivity, preferably having a thermal conductivity of λ_{20°}=40 to 1000 W/(K*m), preferably 100 to 400 W/(K*m) and particularly preferably about 220 W/(K*m) at 20° C. This material preferably includes aluminium as a major component thereof, other components may be in particular manganese, magnesium, copper, silicon, nickel, zinc and beryllium.

In a fibre reinforced composite material, thermal conductivity is achieved particularly by a high proportion of thermally conductive fibres, which are particularly made from a material having the heat conducting properties described in the preceding. In particular, a fibre reinforced composite material has a fibre component of 30 to 95% by volume, preferably from 40 to 80% by volume, and particularly from 50 to 65% by volume.

The cell compartment elements are particularly produced from a hybrid material. For the purposes of the present invention, a hybrid material is understood to be a material of which parts are made from a plastic, particularly a fibre-reinforced plastic, and parts are made from a metal material. In the parts of the hybrid material that are made of metal, the material has particularly good heat conducting properties, in the parts of the hybrid material that are made of fibre-reinforced plastic, it has particularly good heat insulation properties. In particular, this thermal conductivity is less than 0.5 W/(K*m), preferably less than 0.2 W/(K*m) and particularly preferably less than 0.1 W/(K*m), at 20° C. in each case.

By virtue of battery housing's favourable heat conducting properties, and in the case of a hybrid material its good insulating properties, the temperature regulation of the energy storage devices is easily influenced, which in turn increases operating reliability.

In particular, the cell compartment elements are understood to be a thin-walled part produced by formed. This formed part is preferably produced from a sheet metal that is subjected to reshaping production processes such as folding, deep drawing, pressing or punching. This sheet metal particularly has a wall thickness of 0.3 mm-2.2 mm, preferably of 0.8 mm-1.2 mm, especially of 1.0 mm. In particular, by appropriate selection of the wall thickness it is possible to obtain a favourable weight/rigidity ratio (lightweight construction) in the battery housing, with which the electrochemical energy storage devices may be insulated from external stresses, thus increasing operating reliability.

In particular, the cell compartment elements are understood to be a thin-walled part produced by casting. Casting processes are particularly continuous casting or extrusion. A cell compartment element produced by such a casting process preferably has a wall thickness of 1.0 mm-3.0 mm, preferably of 1.8 mm-2.5 mm and particularly preferably of 2.2 mm at least in areas thereof. By appropriate selection of the casting process and the material, the thermal conductivity of the cell compartment elements is improved and thus also the operating reliability of the electrochemical energy storage devices.

In particular, cell compartment elements made from a metal material are provided with a thermally insulating coating, such as microtherm, in the areas where they contact other cell compartment elements. In particular, this thermal insulation layer may be applied by vapour deposition or painting. In particular, the thermal insulation layer is of a light colour, preferably white and it is especially preferable if it has mirroring or reflective properties. This is particularly effective in reducing thermal conduction from one cell compartment element to another.

In particular, the cell compartment elements are understood to be a thin-walled formed part that is produced from a hybrid material. In this context, the cell compartment element is made from plastic particularly at the locations where it is in contact with another cell compartment element. In other areas this cell compartment element is particularly made from a metal material. This design of the cell compartment elements, particularly inhibits the transmission of heat from one cell compartment to another, and thus also the mutual heating effect between the electrochemical energy storage devices, at the same time favouring the dissipation of heat to the environment surrounding the battery housing.

In particular, this plastic area of the cell compartment element is covered with a heat conducting layer, for example a thermally conductive foil, at least in areas and particularly in the area closest to the electrochemical energy storage device. This plastic area is preferably vaporized with a heat reflecting layer. This heat reflecting layer is particularly white or reflective. In particular, this heat conducting layer has a thermally conducting connection with the metal area of the cell compartment element. This heat conducting layer serves particularly to transport a thermal flow away from the electrochemical energy storage device and towards the metal area of the cell compartment element.

Appropriate forming and material selection improves the heat management of the cell compartment elements and thus also the operating reliability of the electrochemical energy storage devices.

A cell compartment element particularly includes a connection area that is provided in order to create a positive locking connection with a cover element. In particular, such a positive locking connection exists between a cover element and multiple cell compartments, preferably between one cover element and all cell compartment elements. The items contained in the cell compartments may thus be protected from external influences, thus increasing operating reliability, by appropriate selection of the type of the connection between the cover element and the cell compartment elements.

In particular, an additional connecting element is provided for the purpose of creating this positive locking connection. Such a connecting element is preferably an essentially elongated component. This connecting element is preferably in material locking connection with the battery housing, in particular at least areas of the connecting element are attached to the battery housing by adhesion. In this way, a material locking connection is created between the connecting element, the cover element and the cell compartment element. The particularly sturdy construction of this connection area thus serves to increase operating reliability.

In particular, the positive locking connection between a cover element and a cell compartment element is created without additional connecting elements. Such a snap-on connection particularly connects a cover element with one or preferably with all cell compartment elements. Such a snap-on connection is preferably a force locking, or particularly preferably a positive locking connection. The particularly simple design of this cover element connecting area is thus associated with only very few possible error sources during assembly and production, thereby increasing the operating reliability of the battery housing.

In particular, two adjacent cell compartment elements have a common connecting area. These cell compartment elements are preferably in contact with one another in this connecting area. The cell compartments are preferably connected to one another in bonded locking manner in this connecting area. In particular, such a bonded locking connection is created by adhesion.

The cell compartment elements are preferably connected to each other in positive locking manner in this connecting area. Additional ribbing, which serves as a connecting area for the battery housing, creates a particularly rigid and thus secure battery housing.

In particular, a temperature regulating medium is present in a battery housing. This temperature regulating medium is provided in order to direct an energy flow. This energy flow is preferably directed towards or away from a cover element. This energy flow is particularly preferably transported towards or away from at least one cell compartment element. In particular, the temperature regulating medium flows through at least one cell compartment element and at least one cover element. In particular, multiple battery housings may be connected via the temperature regulating medium connections, and in this way the temperature regulating medium may easily flow through multiple battery housings. The active adjustment of the temperature of the electrochemical energy storage devices thus increases operating reliability.

In particular, a cell compartment element includes at least one or more perfusion channels. These perfusion channels are provided so that a temperature regulating medium may flow through them. In particular, such perfusion channels between two cell compartment elements are evacuated and the medium does not pass through them. The pressure in such an intermediate space is preferably in the order of 0.9*10⁵ Pascal to 0*10⁵ Pascal, preferably 0.8*10⁵ Pascal to 0.5*10⁵ Pascal, and particularly preferably 0.7*10⁵ Pascal to 0.6*10⁵ Pascal. The evacuation of these perfusion channels lowers the capability of these areas to conduct heat, particularly to less than 0.03 W/(m*K) at 20° C.

In particular, these perfusion channels are filled with a phase-changing material (PCM) that is in the solid phase at ambient temperature, for example a salt or a paraffin. When the temperature inside the perfusion channels rises more than 200° C. or particularly preferably more than 100° C., this phase changing material changes its aggregate state and liquefies. This liquefaction particularly absorbs heat energy. This change in the aggregate state of the substance means that less thermal energy is transferred from one cell compartment to another, thereby further increasing the operating reliability of the electrochemical energy storage devices.

In order to produce a battery housing, cell compartment elements are preferably manufactured in a suitable casting or forming production process. In particular, these cell compartment elements are brought into a predetermined position relative to each other for producing the battery housing. Then, preferably at least one of these cell compartment elements is attached to at least one cover element. In particular, contact points between the cover element and the cell compartment elements that are designed so that a temperature regulating medium may flow through them are connected to each in fluid-tight manner. Such a connection may be created in particular by elastic sealing means such as O-rings, sealing lips, or by a bonded connection using sealing pastes or sealing strips.

In particular, in order to produce a cell compartment element from a hybrid material a metal inlay is placed in mould and the border area thereof is bonded with plastic to form a cell compartment element. This inlay preferably has a recessed structure particularly in this border area, which results in the formation of a particularly strong bond with the plastic portion of the cell compartment element.

In particular, a cell compartment element is joined to a cover element in bonded manner, preferably by gluing or welding.

Further advantages and embodiments of the present invention will be evident from the accompanying drawing.

### BRIEF DESCRIPTION OF THE DRAWINGS

FIG. 1 shows a battery housing for electrochemical energy storage devices comprising a plurality of cell compartment elements and two cover elements, wherein ports for a temperature regulating medium are provided on one cover element.

FIG. 2 shows two cell compartment elements with electrochemical energy storage devices. The cell compartment elements are produced from sheet metal and form a positive locking connection in their connecting area. An elastic equalization element is located between two electrochemical energy storage devices.

FIG. 3 shows two different cell compartment element designs. These cell compartment elements are constructed as continuous casting profiles. In FIG. 3b, two cell compartment elements form a double wall through which a temperature regulating medium is able to flow.

FIG. 4 shows two different designs for cell compartment elements produced from sheet metal. In FIG. 4a, a channel for the temperature regulating medium is inset into the cell compartment element and a temperature regulating medium is able to flow through it. FIG. 4b shows a cell compartment element with multiple cooling ribs, which are designed to increase the surface area of the cell compartment element, thus improving thermal conductivity.

FIG. 5 shows two different designs for cell compartment elements produced from continuous casting profiles. In FIG. 5a, perfusion channels are conformed in the cell compartment element and a temperature regulating medium is able to flow through these channels. FIG. 5b shows a cell compartment element having multiple cooling ribs, designed to increase the surface area of the cell compartment element, thus improving thermal conductivity.

FIG. 6 shows the connecting area between cell compartment elements and a cover element, wherein the connection is assured by a connecting element. This connecting element is attached to the cover element and the cell compartment elements by gluing.

FIG. 7 shows the connecting area between cell compartment elements and a cover element, wherein the connection is assured by a snap-on connection.

FIG. 8 shows different possibilities for perfusing cell compartment elements, wherein the flow of temperature regulating medium is controlled by the cover element.

FIG. 9 shows a cell compartment element made from a hybrid material.

### DETAILED DESCRIPTION

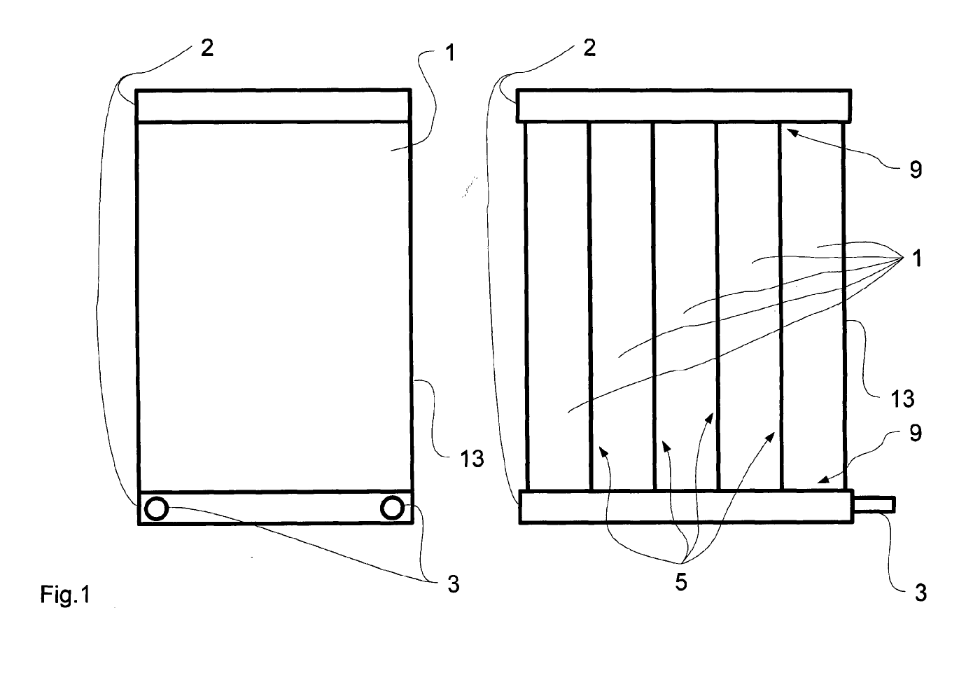

The present invention will first be explained using an example based on the drawing in FIG. 1.

FIG. 1 shows a battery housing for holding electrochemical energy storage devices 15. This battery housing has two cover elements 2 and a plurality of cell compartment elements 1. Two ports 3 for a temperature regulating medium are conformed in a cover element 2. The temperature regulating medium flows into cover element 2 through one of these ports. From cover element 2, the temperature regulating medium flows through cell compartment elements 1 and back to second port 3.

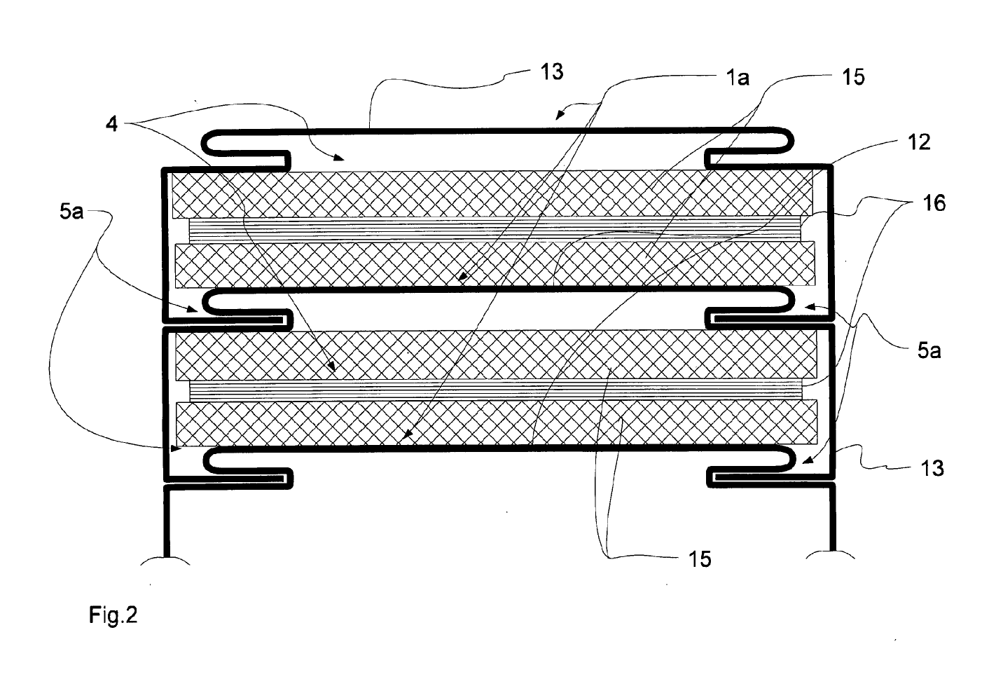

FIG. 2 shows two cell compartment elements 1a made from sheet metal. Together, these cell compartment elements 1a form a connection area 5a. In this connecting area 5a the two cell compartment elements 1a are connected to one another in positive locking manner. Cell compartments 4 are separated from each other by a partition wall 13. Two electrochemical energy storage devices 15 are located in each of the cell compartments 4. These energy storage devices 15 are pressed against cell compartment element 1 by elastic equalization elements 16, thereby creating a thermally conductive connection between cell compartment element 1 and energy storage device 15.

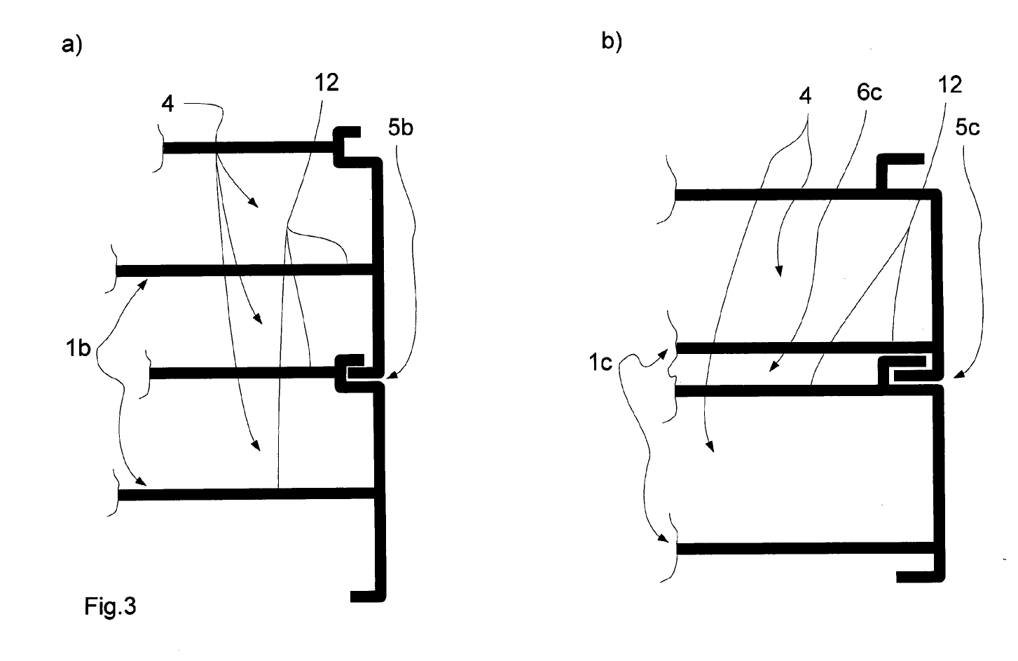

FIG. 3a shows two cell compartment elements 1b. These cell compartment elements 1b are produced from a continuous casting profile. The two cell compartment elements 1b form a shared connection area 5b with one another. In this connection area, cell compartment elements 1b are connected to each other in positive locking manner.

FIG. 3b shows two cell compartment elements 1c that are produced from a continuous casting profile. The two cell compartment elements 1c form a shared connection area 5c with one another. This connection between the two cell compartment elements 1c gives rise to a double wall cavity 6c between them. This cavity 6c is designed to allow a temperature regulating medium to flow through it. The two cell compartment elements 1c are connected with one another in fluid-tight manner in their connecting area 5c. Appropriate selection of the wall thickness in the area of double partition wall 12 creates an elastic area of cell compartment element 4. The provision of this elastic area of cell compartment elements 1c means that the elastic equalization element 16 between energy storage devices 15 is not required.

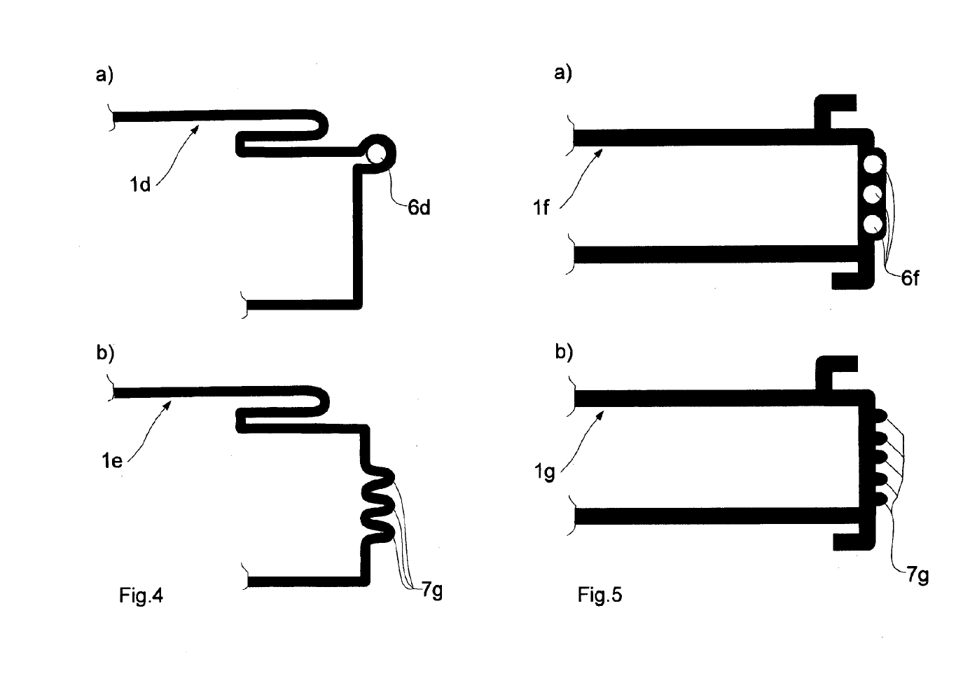

FIG. 4a shows a cell compartment element 1d that is produced from sheet metal. This cell compartment element 1d is specially conformed to enable a line 6d for the temperature regulating medium to be incorporated in cell compartment element 1d. This temperature regulating medium line 6d is designed to allow a temperature regulating medium to flow through it.

FIG. 4b shows a cell compartment element 1e that is produced from sheet metal. This cell compartment element 1e is furnished with a plurality of cooling ribs 7e. These cooling ribs 7e serve to increase the surface area of cell compartment element 1e, thus providing improved thermal conductivity.

FIG. 5a shows a cell compartment element 1f that is produced from a continuous casting profile. This cell compartment element 1f is furnished with perfusion channels 6f. These recesses 6f are designed to allow a temperature regulating medium to flow through them. These perfusion channels 6f may also be located in partition walls 12. The perfusion channels 6f in cell compartment elements if may also be connected to the perfusion channels 14 in the cover (now shown).

FIG. 5b shows a cell compartment element if that is produced from a continuous casting profile. This cell compartment element if is furnished with a plurality of cooling ribs 7f. These serve to increase the surface area of cell compartment element 1f. The larger surface area serves to improve thermal conductivity. At the same time, cooling ribs 7f are advantageously aligned in such manner that an air flow either artificially generated or created by warming of the ambient air flows over them in the lengthwise direction of the ribs.

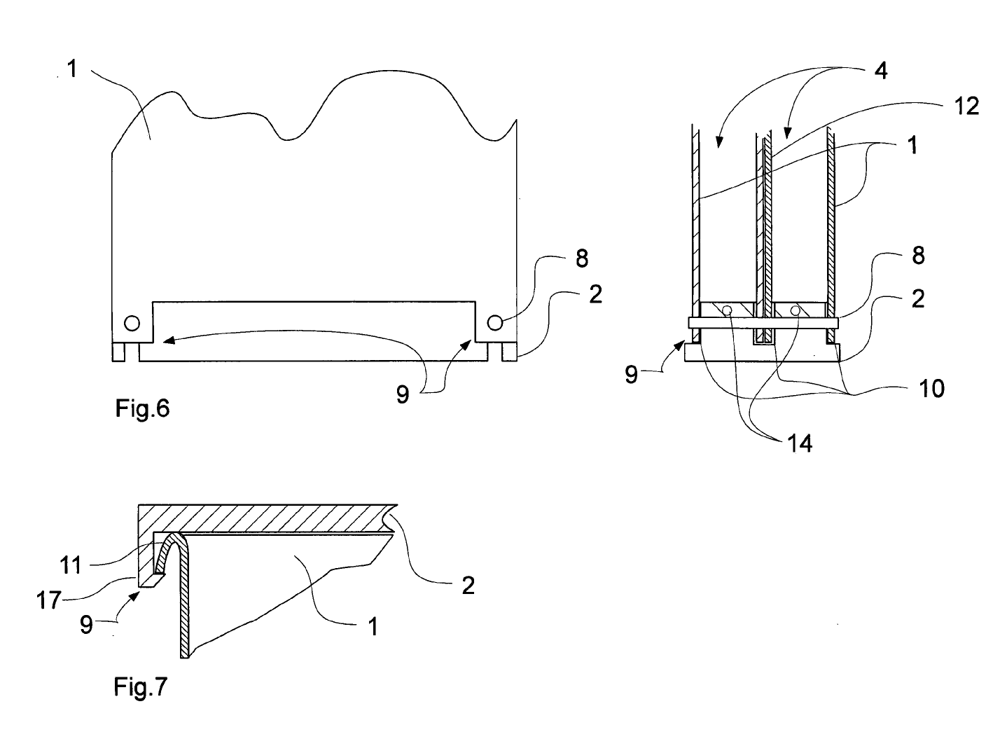

FIG. 6 shows connecting area 9 between a cover element 2 and cell compartment elements 1. Cover element 2 has a series of cell compartment cutouts 10. Cell compartment elements 1 engage in these cutouts 10. Cell compartment elements 1 and cover element 2 are joined to each other in positive locking manner by a connecting element 8. This connecting element 8 is connected in bonded manner by adhesion to cell compartment elements 1 and cover element 2. Alternatively, connecting element 8 may be connected to cover element 2 or to cell compartment elements 1 by fastening means such as bolts, rivets or pins.

FIG. 7 shows connecting area 9 between a cover element 2 and cell compartment elements 1. The cell compartment elements are specially shaped for form this snap-on connection. The cell compartment elements are furnished with a snap zone 11 that is able to undergo elastic deformation. Cover element 2 has a locking section 17, in which this snap zone 11 of cell compartment element 1 is able to engage. The detent connection may also be produced by additional spring and auxiliary elements.

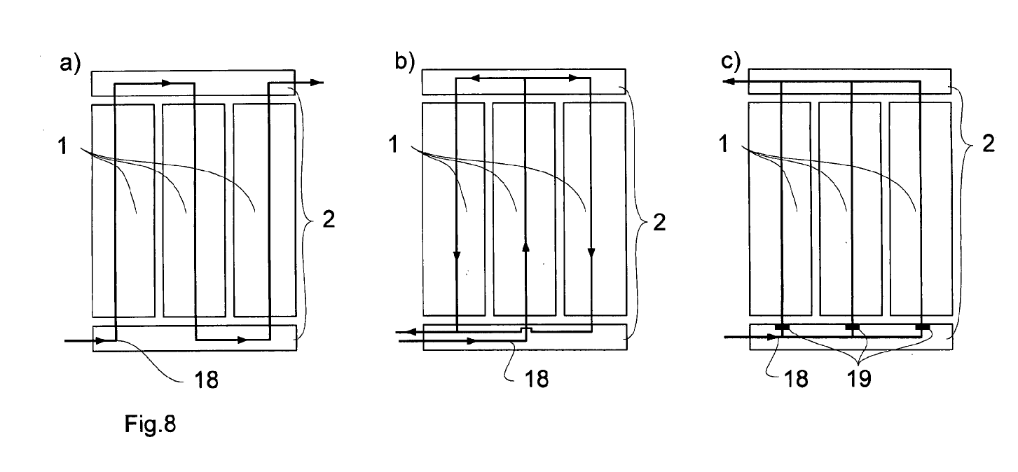

FIG. 8 shows various possible configurations for the flow of medium through the cell compartment elements.

FIG. 8a shows a flow through three cell compartment elements one at a time. Temperature regulating medium stream 18 enters a cover element 2 and from there is forwarded to an outer cell compartment element 1. From there, the temperature regulating medium flows through one cell compartment element 1 after the other. Temperature regulating medium stream 18 flows out again at a second cover element 2.

FIG. 8b shows another embodiment for the flow of medium through multiple cell compartment elements 1. In this embodiment the temperature regulating medium stream first flows in through cover element 2 and is directed to a cell compartment element 1. This cell compartment element is at least partially surrounded by other cell compartment elements 1. From this first cell compartment element 1, temperature regulating medium stream 18 splits in a second cover element 2 and then flows through two more cell compartment elements 1 at the same time (in parallel). Temperature regulating medium stream 18 flows out of the same cover element 2 as the one through which it entered previously.

FIG. 8c shows a further embodiment of a route by which a medium may flow through multiple cell compartment elements 1. In this case, a cover element 2 is furnished with temperature regulating medium valves 19. These temperature regulating medium valves 19 may be used to direct temperature regulating medium 18 deliberately to individual cell compartment elements 1. In particular, not all cell compartment elements 1 have to be reachable with their own temperature regulating medium valve 19. In particular, these temperature regulating medium valves are thermostats. Such thermostats allow temperature regulating medium 18 to flow into cell compartment elements 1 or block its passage, or inhibit the flow volume thereof. Such thermostats operate on the basis of temperature, for example the temperature of temperature regulating medium 18.

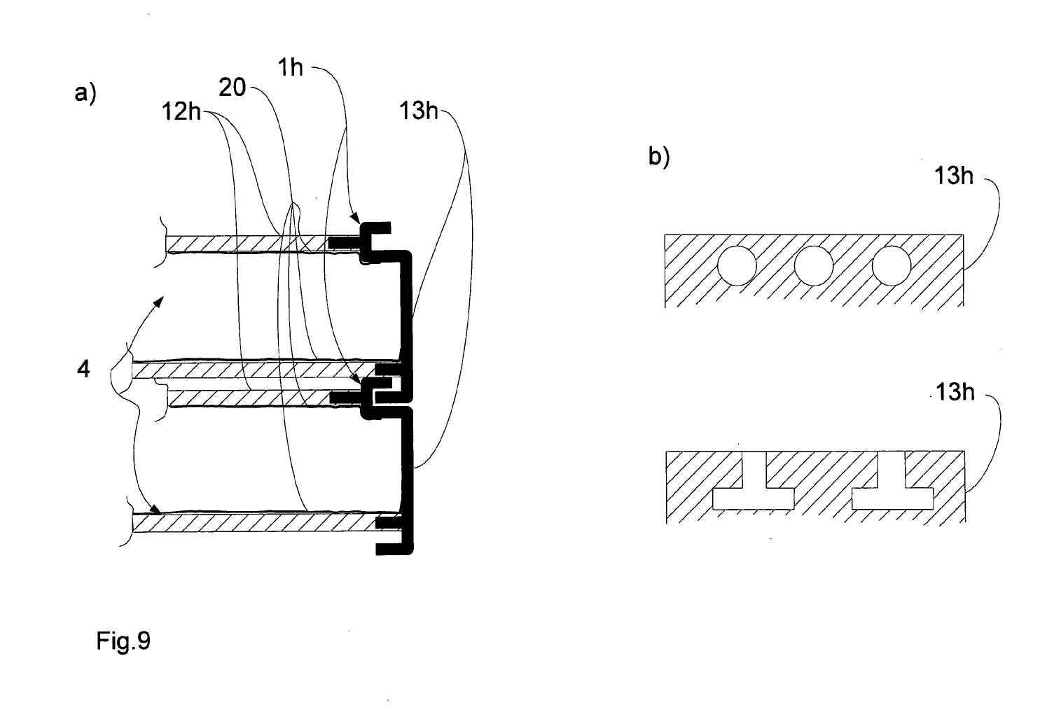

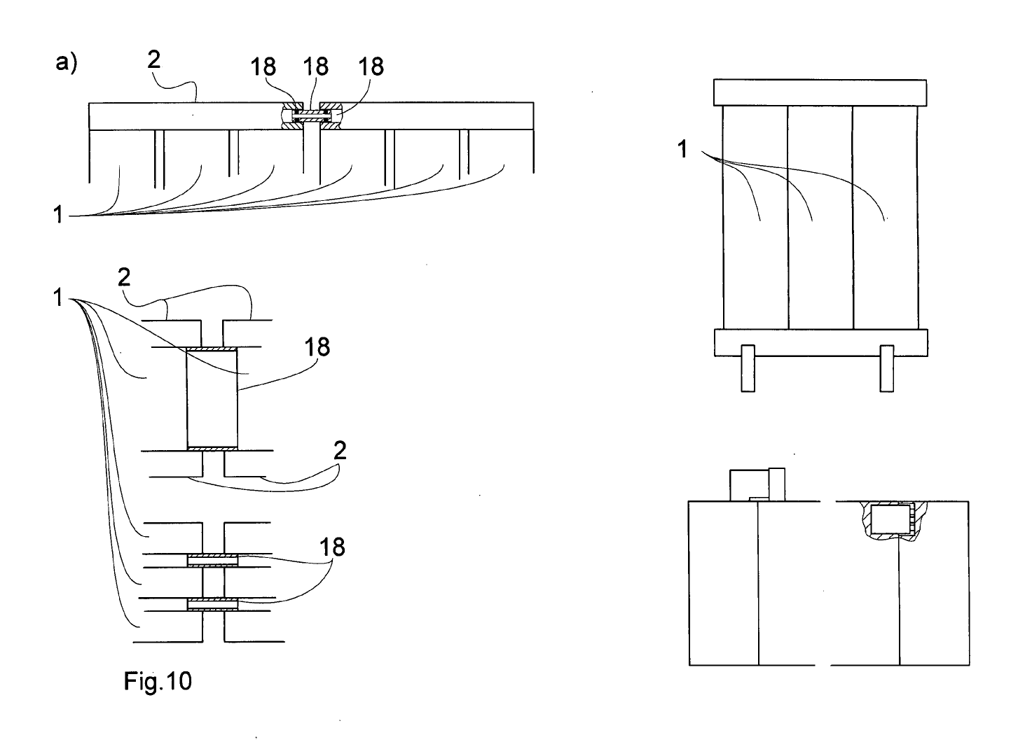

FIG. 9 shows an embodiment of a cell compartment element 1h that is produced from a hybrid material. In this context, the transfer of heat from one cell compartment element to another is prevented by the thermal insulation effect of plastic partition wall 12h (FIG. 9a). On the other hand, the transfer of heat from a cell compartment element 1h to the atmosphere surrounding the cell compartment element is favoured by lateral wall 13h, which is made from a metal material. Lateral wall 13h is on thermally conductive connection with heat conducting foil 20. Heat conducting foil 20 conducts a temperature stream away from the surface of the electrochemical energy storage device and transfers it to lateral wall 13h. In this way, an effective measure is provided for preventing the electrochemical energy storage devices in adjacent cell compartments from heating each other up. FIG. 9b shows various possible designs for the border area of lateral wall 13h. The cutouts in lateral wall 13h result in an improved connection between metal lateral wall 13h and partition wall 12h, which is made from plastic.

1-15. (canceled)

16. A battery housing for holding a plurality of electrochemical energy storage devices, the battery housing comprising:
a plurality of cell compartments configured to hold a plurality of electrochemical energy storage devices, wherein the cell compartments are formed by connecting a plurality of cell compartment elements.

17. The battery housing as recited in claim 1, wherein two adjacent cell compartment elements are connected to one another in a shared connection area by a bonding connection,

18. The battery housing as recited in claim 17, wherein the two adjacent cell compartment elements are connected by adhesion and/or by positive locking means.

19. The battery housing as recited in any claim 16, wherein the cell compartment elements form lateral walls of the battery housing.

20. The battery housing as recited in claim 16, wherein the battery housing is closable by at least one cover element.

21. The battery housing as recited in claim 20, wherein the at least one cover element has an area configured to form a positive locking connection with at least one cell compartment element.

22. The battery housing as recited in claim 16, wherein the cell compartment elements are stacked on top of each other, arranged side by side, or nested inside each other.

23. The battery housing as recited in claim 16, wherein the cell compartment elements are produced from a metal material,

24. The battery housing as recited in claim 23, wherein the cell compartment elements
are made from a thin-walled shaped part made in a forming process, preferably a folded metal sheet, wherein this metal sheet has a wall thickness of 0.3 mm to 2.2 mm or
are made from a thin-walled shaped part made in a casting process, preferably a continuous casting profile, wherein at least sections of this profile have a wall thickness of 1 mm to 3 mm.

25. The battery housing as recited in claim 16, further comprising at least one cover element having an area that is configured to create a positive locking connection with at least one cell compartment element.

26. The battery housing as recited in claim 16, further comprising at least one cover element having an area that is configured to create a positive locking connection with all of the cell compartment elements.

27. The battery housing as recited in claim 25, wherein an additional connecting element is used to create the positive locking connection.

28. The battery housing as recited in claim 27, wherein the connecting element is connected to the battery housing in a bonded manner

29. The battery housing as recited in claim 25, wherein a snap-on connection is used to create this positive locking connection.

30. The battery housing as recited in claim 16, wherein a temperature regulating medium can flow through the battery housing and is provided in order to transport an energy stream from at least one cover element or from two cover elements, from one cell compartment element or from multiple cell compartment elements away from or towards such elements.

31. The battery housing as recited in claim 16, wherein the cell compartment elements are furnished with perfusion channels or two adjacent cell compartment elements form perfusion channels that are designed to allow a temperature regulating medium to flow through them.

32. The battery housing as recited in claim 16, wherein a cover element or a cell compartment element contains temperature regulating medium valves.

33. A battery comprising a plurality of electrochemical energy storage devices, wherein the energy storage devices are arranged in a battery housing according to claim 16.

34. A method for producing a battery housing according to claim 16, comprising:
producing a plurality of cell compartments by connecting a plurality of cell compartment elements with each other.

35. The method for producing a battery housing as recited in claim 34, further comprising:
connecting a cover element to a cell compartment element in fluid-tight manner at least in an area of perfusion channels.
